(19) United States
(12) Patent Application Publication
(10) Pub. No.: US 2018/0288973 A1
(43) Pub. Date: Oct. 11, 2018

(54) Novel dog leash

(71) Applicant: Silong CHEN, Guangdong (CN)

(72) Inventor: Silong CHEN, Guangdong (CN)

(21) Appl. No.: 15/610,583

(22) Filed: May 31, 2017

(30) Foreign Application Priority Data
Apr. 7, 2017 (CN) 201710224639.1

(51) Int. Cl. A01K 27/00

(52) U.S. Cl. CPC A01K 27/004; A01K 27/003

(57) ABSTRACT

A novel dog leash includes a case with a receiving space, a reel, a switch button, a transmission member, and a braking paddle, with an axle core positioned therein and sheathed in the reel; spaced braking positions configured on the reel, corresponding to the braking paddle; the braking paddle pivoted in the case, including a first pivoted end and a first free end; the transmission member pivoted in the case, including a second pivoted end and a second free end; the second free end and the first pivoted end positioned on two opposite ends of a first spring, while the second pivoted end and the first free end on that of the second spring. The second pivoted end cooperates with the switch button extending to the outside of the case. With this structure, the rotation suspending or locking of reel may be achieved, with a high braking reliability.

### BACKGROUND OF THE INVENTION

The present invention relates to a technical field of daily used necessities, particularly to a novel dog leash.

With the continuous improvement of human life standards, pet dogs have brought much fun into human life, and thus it has been a part of human life to keep pet dogs. When people go outing with their treasured pet dogs, a dog leash is necessary for leading the dogs, in case that their treasured pet dogs get lost or attack people accidentally, preventing accidents occurring.

The dog leash in the prior art, includes a case, a braking member, an elastic member, a reel, a tension spring, and a button. When pressure is applied on the button, the button drives the braking member to overcome the force of elastic member to rotate, so that the braking member then stop at the reel, thus realizing the function of suspending rotation of the reel. When the pressure is relieved, the elastic member resets the button and the braking member under the action of the tension spring. However, that dog leash involves a poor braking reliability after a long time use, and may not properly fulfill the using demands of users.

Therefore, improvements are needed in the prior art.

### BRIEF SUMMARY OF THE INVENTION

Aiming at the shortcomings in the prior art, the objective of the present invention is to provide a novel dog leash with a reasonable structure and a high braking reliability.

In order to solve the above technical problem, an embodiment of the present invention provides a novel dog leash, including a case, a reel, a switch button, a transmission member, and a braking paddle, wherein a receiving space is configured in the case, with an axle core positioned in the receiving space, and the axle core is sheathed in the reel; spaced braking positions are configured on the reel, corresponding to the braking paddle; the braking paddle is pivoted in the case, including a first pivoted end and a first free end; the transmission member is pivoted in the case, including a second pivoted end and a second free end; the dog leash further includes a first spring and a second spring, received in the case; the first pivoted end of the braking paddle is fixed to one end of the first spring, the other end of the first spring contacts to the second free end of the transmission member; the second pivoted end of the transmission member is fixed to one end of the second spring, the other end of the second spring contacts to the first end of the braking paddle. The second pivoted end of the transmission member cooperates with the switch button, the switch button extending to the outside of the case. The braking paddle includes a first protrusion, while a second protrusion cooperating with the first protrusion is formed on the switch button, in the case.

Compared with the prior art, the present invention possesses advantages that it is possible to realize the function of suspending or locking the rotation of the reel, as well as a high braking reliability, with the application of the above-mentioned structure, i.e., the cooperation between switch button and transmission member, as well as the braking paddle.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an illustrative structural view of a dog leash in accordance with an exemplary embodiment of the present disclosure.

FIG. 2 is an illustrative view of a switch button and a braking paddle in accordance with a further exemplary embodiment of the present disclosure.

FIG. 3 is enlarged view of part P in accordance with a the exemplary embodiment of the present disclosure illustrated in FIG. 1.

Hereinafter, the reference numerals designate corresponding parts as follows.

1: case, 2: reel. 3: button switch; 4: transmission member; 5: braking paddle, 6: receiving space, 7: axle core, 8: braking position, 9: first spring, 10: second spring, 11: first protrusion, and 12: second protrusion.

### DETAILED DESCRIPTION OF THE INVENTION

The present invention will hereinafter be described in detail with reference to an exemplary embodiment.

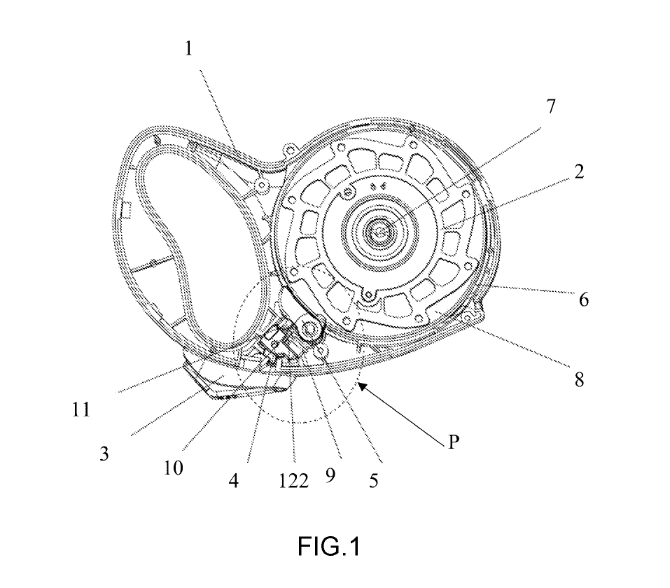

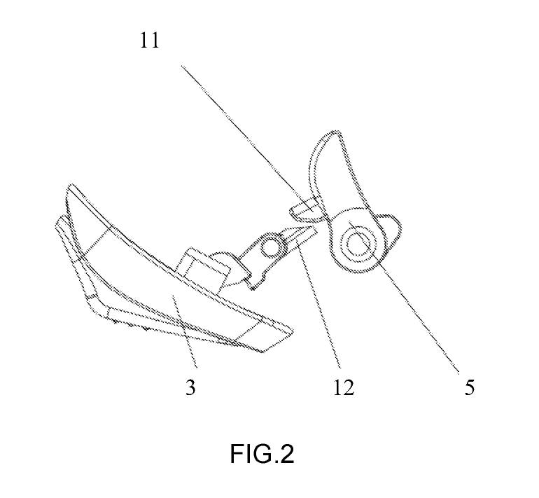

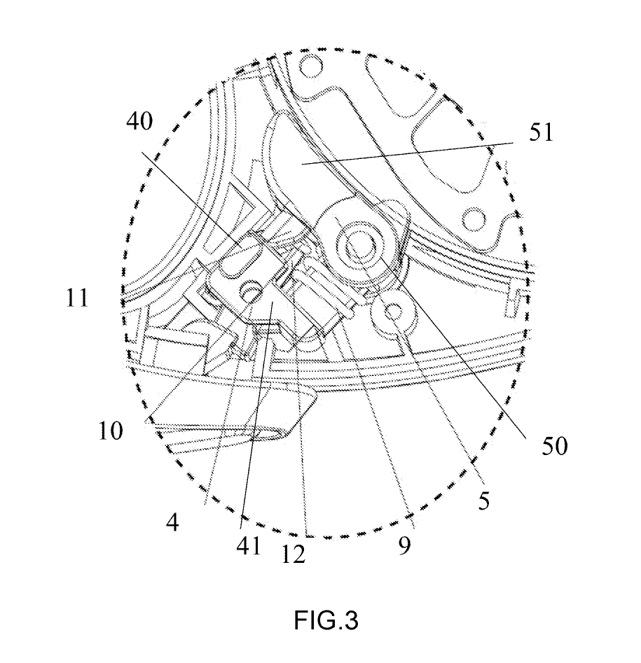

Referring to FIG. 1 and FIG. 2, a novel dog leash is disclosed in this disclosure, which includes a case 1, a reel 2, a switch button 3, a transmission member 4 and a braking paddle 5. The case 1 is provided with a receiving space 6, with an axle core 7 received therein. The axle core 7 is sheathed in the reel 2. Braking positions with spaced configuration are formed on the reel 2, corresponding to the braking paddle 5. The braking paddle 5 is pivoted in the case 1. The dog leash in this embodiment further includes a first spring 9 and a second spring 10. Specifically, as shown in FIG. 3, the braking paddle 5 incudes a first pivoted end 50 and a first free end 51. The transmission member 4 includes second pivoted end 40 and a second free end 41. Herein, the first pivoted end 50 is fixed on one end of the first spring 9, while the other end of the first spring 9 contacts to the second free end 41 of the transmission member 4. The transmission member is pivoted in the case 1 by the second pivoted end 40. The second pivoted end 40 is fixed to one end of the second spring 10, while the other end of the second spring 10 contacts with the second free end 51 of the braking paddle 5. As shown in FIG. 3, the second free end 41 and the first pivoted end 50 are respectively positioned on two opposite ends of the first spring 9, while the second pivoted end 40 and the first free end 51 are respectively configured on two opposite ends of the second spring 10. The second pivoted end 40 of the transmission member 4 cooperates with the switch button 3, the switch button 3 extending to the outside of the case 1. As shown in FIG. 2, a first protrusion 11 is configured on the braking paddle 5, and a second protrusion 12 is formed on one end of the switch button, inside the case 1. The first protrusion 11 cooperates with the second protrusion 12.

During operation, when pressure is applied onto the switch button 3, the switch button 3 resists to the second pivoted end 40 of the transmission member 4, the transmission member 4 reaches to and pushes the first free end 51 of the braking paddle 5, then the second spring 10 is compressed, the braking paddle 5 thus rotates till the first free end 51 is stuck to the braking position, in which case, it may be realized to bring the rotation of the braking paddle 5 in to a pause. Meanwhile, the first protrusion 11 of the braking paddle 5 resists to the second protrusion 12 of the switch button 3, and thus the first free end 51 of the braking paddle 5 may not get relieved from the braking position. When the pressure on the switch button is released, the force applied on the transmission member 4 disappears, and the second spring 10 gets released to reset the transmission member 4, the transmission member 4 then rotates, with the second free end 41 of the transmission member 4 moving to resist the first spring 9, and the first spring 9 resists the first pivoted end 50 of the braking paddle 5, to get the braking paddle 5 reset.

In summary, with the structure designed on above, the shortcomings of the prior art may be eliminated, and the structure in present disclosure also possesses advantages of a reasonable structure and a high braking reliability.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A novel dog leash, comprising:
a case, a reel, a switch button, a transmission member and a braking paddle;
the case configured with a receiving space, with an axle core positioned in the receiving space, the axle core sheathed in the reel;
the reel comprising spaced braking positions corresponding to the braking paddle;
the braking paddle pivoted in the case, comprising a first pivoted end and a first free end;
the transmission member pivoted in the case, comprising a second pivoted end and a second free end;
the dog leash further comprising a first spring and a second spring, received in the case;
the first pivoted end of the braking paddle fixed to one end of the first spring, the other end of the first spring contacting to the second free end of the transmission member;
the second pivoted end of the transmission member fixed to one end of the second spring, the other end of the second spring contacting to the first end of the braking paddle;
the second pivoted end of the transmission member cooperating with the switch button in the case, the switch button extending out of the case.

2. The novel dog leash as described in claim 1, wherein, the braking paddle comprises a first protrusion, and the switch button comprises a second protrusion in the case, the second protrusion cooperating with the first protrusion.
